(19) United States
(12) Patent Application Publication
(10) Pub. No.: US 2010/0063718 A1
(43) Pub. Date: Mar. 11, 2010

(54) Aircraft center of gravity automatic calculating system

(76) Inventor: Willard H. Schmidt, Albuquerque, NM (US)

Correspondence Address: Willard H. Schmidt, 2015 Altez NE, Albuquerque, NM, 87112, US

(21) Appl. No.: 12/283,013

(22) Filed: Sep. 10, 2008

(51) Int. Cl. G01M 1/12

(52) U.S. Cl. 701/124

(57) ABSTRACT

This invention describes the system and the means for continuous monitoring of center of gravity and total weight of an airplane at rest on the ground. Information from strain gauge transducers located on structural members for the nose wheel and main landing gear is communicated to a computer where calculations are made and data is transmitted to gauges in the airplane cockpit. Range limits for the airplane center of gravity with respect to the center of lift, and also the total airplane weight overload limit are clearly indicated on the respective gauges. This invention makes possible the proper loading of an airplane, which makes for efficient trimming to save fuel. This invention also guarantees proper weight distribution in the airplane consistent with the center of lift and center of gravity limits. This is a huge safety factor for airplane passengers, flight crew, and the public.

### BACKGROUND AND DESCRIPTION OF PRIOR ART

The center of gravity (CG) and total weight of aircraft are critical parameters for aircraft performance and safety. Very often these parameters are not known at the time of take-off. The consequences can be deadly. The airplane pilot may not be able to control the plane because of improper load distribution. In the case of overloading, the airplane may not have sufficient power to achieve lift and avoid stalling.

Airplane manufacturers supply center of gravity and maximum gross weight specifications for each aircraft. The center of gravity (CG) is the point where all of the weight of the aircraft can be considered to be located. Likewise, the center of lift (CL) is the place where the total lift of the airplane is considered to be located, and it is specified by the airplane manufacturer. To fly safely the CG must be within certain limits of the center of lift. There is a forward and aft limit for CG location that must not be exceeded in order for proper balance and control of the aircraft.

Most often, the total weight of the airplane and the location of the center of gravity are not accurately known at the time of take-off. This presents a potentially dangerous situation because control of the airplane may be sacrificed unknowingly. Before take-off, when a pilot is concerned about center of gravity location and weight of the aircraft, load weights are measured or estimated, and the location of loads is either known or measured. From this information the center of gravity and weight of the aircraft are calculated. At best, these values are approximate. Consequently, the airplane flies with only inexact information critical for control of the aircraft. The safety of passengers, crew, airplane and the public are compromised. It is the purpose of this patent application to change that by making exact center of gravity and total weight data continuously available to the airplane pilot on his cockpit instrument panel.

### SUMMARY OF INVENTION

This invention describes the means and equipment necessary for an aircraft center of gravity and total weight automatic calculating system. At rest an airplane contacts the ground essentially at three points. There is usually the nose wheel in front and one main gear wheel on either side of the fuselage. These constitute the three contact points where the total weight of the aircraft is transmitted to the ground. With this information and the location of the wheels at the contact points it is possible to accurately determine the total weight of the airplane and the center of gravity. Weight at each of the three contact points is determined by strain gauges and other means. A transducer at each of the three contact points transmits weight information to a center of gravity and total weight computer. This data is transmitted by cables to gauges on the instrument panel in the cockpit of the aircraft.

### DRAWING FIGURES

FIG. 1 is an airplane center of gravity diagram. The three contact points at which airplane weight is transmitted to the ground are shown. The forward and aft center of gravity limits relative to the center of lift are also shown.

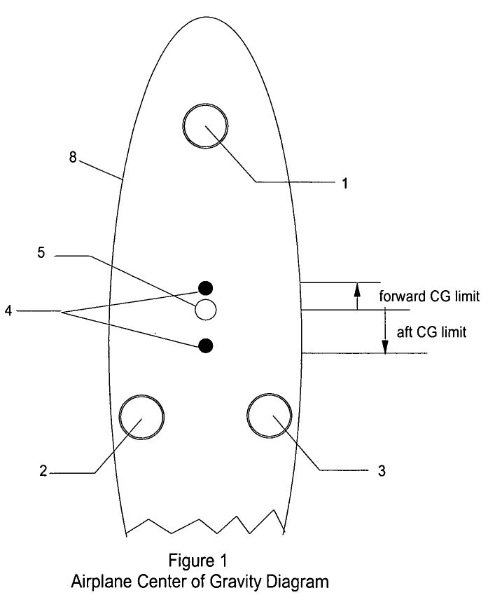

FIG. 2 indicates the distances of the nose wheel contact point and the main gear wheels contact points from the center of gravity of the aircraft.

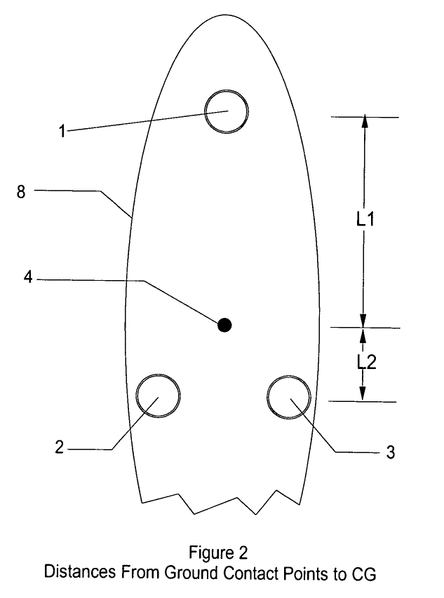

FIG. 3 illustrates the center of gravity and total weight instrument system. Data from the three contact point transducers is processed and displayed by gauges located on the cockpit instrument panel.

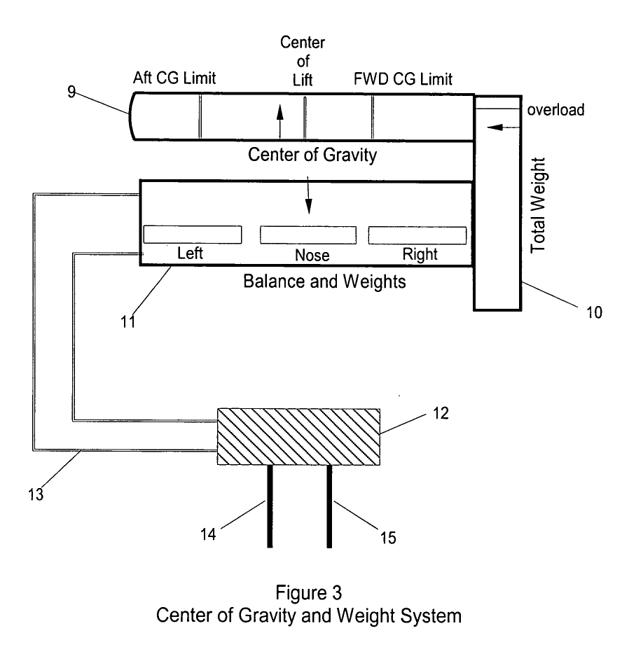

### REFERENCE NUMERALS IN DRAWINGS

1. Ground contact point no. 1.
2. Ground contact point no. 2.
3. Ground contact point no. 3.
4. Center of gravity (CG).
5. Center of lift (CL).
6. Forward CG limit.
7. Aft CG limit.
8. Airplane fuselage.
9. Ground CG gauge.
10. Total weight gauge.
11. Balance and weights gauge
12. CG and weights computer.
13. Cables from computer to gauges.
14. Signal cable from contact point no. 1.
15. Signal cable from contact points no. 2 and no. 3.

### DESCRIPTION OF INVENTION

This invention describes the system and the means to continuously present the center of gravity and the total airplane weight on an instrument panel in the airplane cockpit.

An airplane at rest on the ground transmits weight to the surface of the runway from the nose wheel located at contact point no. 1, 1, and from the main gear wheels located at contact point no. 2, 2, and contact point no. 3, 3. Strain gauges on airplane structural members at these contact points 1,2,3 feed data to transducers at these locations. Data from the respective transducers is fed to the center of gravity and weights computer 12 that has stored in it the longitudinal distance between the nose wheel contact point 1 and the main gear contact points 2,3. The center of gravity and weights computer 12 can then make center of gravity and total weight calculations. This information is sent through cables 13 from center of gravity and weights computer 12 to center of gravity and weight gauges 9, 10, 11 located on the instrument panel in the airplane cockpit. These gauges 9, 10, 11 continuously display the location of the center of gravity and the total weight of the airplane. The airplane weights at the nose gear and left and right main gear locations are digitized and displayed on the balance and weights data panel 11. Center of gravity gauge 9 also indicates the location of the center of lift and also the forward and aft CG limits. The airplane total weight gauge shows the weight of the airplane and the overload limit. These indicated limits on the respective gauges provide essential safety information to the pilot.

### OPERATION OF THE INVENTION

Information from transducers at the airplane ground contact points 1,2,3 provide data used in CG and weights computer 12. The distance between the nose wheel ground contact point 1 and the main gear contact points 2,3 is stored in the computer 12. With this information the total airplane weight and location of the center of gravity of the airplane can be calculated.

The total weight of the airplane is calculated in computer 12 by summing together the data from strain gauges at contact points 1,2, 3 that has been translated into weights. This information is then indicated on the total weight gauge 10.

A straightforward moments calculation is made by computer 12 to determine the location of the airplane center of gravity. Airplane weight data from strain gauge transducers located at ground contact points 1, 2, and 3, together with the known longitudinal distance between ground contact point 1 and ground contact points 2 and 3 provide the necessary input information.

The algebraic equation for this calculation is as follows:

The airplane longitudinal distance between the nose wheel contact point 1 and the main gear contact points 2,3 is defined by the symbol L. The weight at ground contact point 1 is defined as W₁, and the sum of the weights at ground contact points 2,3 is called W_{2.}

The longitudinal distance to the center of gravity from ground contact points no. 2 and no. 3 is D₂.

$${D}_{2} = \frac{{W}_{1} L}{{W}_{1} + {W}_{2}}$$

The longitudinal distance to the center of gravity from ground contact point no. 1 is called D₁.

$${D}_{1} = L - \frac{{W}_{1} L}{{W}_{1} + {W}_{2}}$$

I claim:

1. A system and equipment that automatically and continuously calculates the center of gravity and total weight of an airplane at rest on the ground and transmits this information to instrument gauges in the cockpit of the airplane.

2. Strain gauges and signal transducers of claim 1 located on structural members of the airplane relative to the nose wheel and the main landing gear for airplane center of gravity and total weight measurements.

3. A center of gravity and total airplane weight computer of claim 1 to process data from claim 2 strain gauges and signal transducers.

4. Input data from strain gauge transducers of claim 1 located on airplane structural members at ground contact locations of an airplane at rest on the ground for center of gravity calculations by claim 3 computer.

5. Computer mathematical formulas of claim 1 for calculations by claim 3 computer for airplane center of gravity location and total airplane weight based on data from ground contact locations of the airplane at rest on the ground.

6. A center of gravity gauge with an indicator needle to show the center of gravity location of an airplane at rest on the ground.

7. Markings on the center of gravity gauge of claim 6 that indicate the center of lift, aft CG limit, and fwd CG limit.

8. An airplane total weight gauge with an indicator needle to show the total airplane weight, and a marking on the gauge to indicate weight overload.

9. An airplane balance and weights gauge of claim 1 with an indicator pointer to show the balance of weights between the left and right main landing gear of an airplane, together with digital read outs of weight supported respectively by the left main gear, nose wheel, and right main gear in that order.
